(19) United States
(12) Patent Application Publication
(10) Pub. No.: US 2014/0159409 A1
(43) Pub. Date: Jun. 12, 2014

(54) TRUCK BED TO PASSENGER COMPARTMENT INTEGRATING MECHANISM IN DOUBLE CAB PICKUP TRUCKS

(71) Applicant: Luis Pablo Razza, San Carlos de Bariloche (AR)

(72) Inventor: Luis Pablo Razza, San Carlos de Bariloche (AR)

(21) Appl. No.: 14/093,068

(22) Filed: Nov. 29, 2013

(30) Foreign Application Priority Data
Dec. 12, 2012 (AR) 20120104667

(51) Int. Cl. B60P 3/42

(52) U.S. Cl. CPC B60P 3/42
USPC 296/24.33

(57) ABSTRACT

A truck bed/passenger compartment; the truck railings having windows having locking hinged back edges connected to a horizontally opening backdoor; passenger compartment backrest having a hinged door at the lintel (sixth door), having a panel as high as the passenger compartment and as wide as the span between the upper edges of said railings, in the lower edge of which an occasional shorter panel may be folded inwards so the sixth door may be vertically pulled out between a position separating the passenger compartment from the truck bed and a horizontal position to provide a roof for the truck bed, occasionally expanding the existing shorter panel when the truck bed length exceeds the height of the sixth door, integrating the truck bed with the passenger compartment; weather stripping for air tightness; access being blocked by closing the back door and having internal automatic locking system for both positions is provided.

### CROSS-REFERENCE TO RELATED APPLICATION

This application claims priority to Argentinean Patent Application No. 20120104667, filed Dec. 12, 2012, the disclosure of which is hereby incorporated by reference in its entirety.

### BACKGROUND

Double cab pickup trucks are known to come with toppers which, depending on the model line, are installed over the truck bed to externally determine the integral appearance of a passenger vehicle, but without achieving such integration inside due to the fixed separation from the double cab, forcing access into the added compartment through the inconvenient back door, which must be opened by vertically pulling it down.

Considering that users who purchase this type of vehicle and its complementary topper intend to alternatively take advantage of the family transportation and work tool options, such alternation implies the tiresome action of mounting and removing the topper and the need to have a safe place available to store it when not in use.

What is needed, in compliance with the described functional features applied to double cab pickup truck bodies from different manufacturers, is a powerful and comfortable utility terrain, capable of meeting the requirements of open top cargo transportation with no height restrictions, cargo transportation in a closed compartment protected against the weather and theft loss, and passenger transportation.

### OBJECTS OF THE INVENTION

In view of the foregoing, an object of the invention is to provide a truck bed to passenger compartment integrating mechanism in double cab pickup trucks that is as easy to operate as the action of opening and closing a door and which does not require any removable pieces.

Another object of the present invention is to offer, by implementing the mechanism described as the main object, the possibility of occasionally adding a third line of seats to provide a wide compartment capable of comfortably holding a larger number of passengers and/or a large luggage trunk, considering the possibility that such third line of seats is stored below the truck bed to be spread out in the integrated option.

### SUMMARY OF THE INVENTION

The present invention refers to a truck bed to passenger compartment integrating mechanism in double or extended cab pickup trucks.

Aspects of the present invention include the arrangement of the truck bed and the passenger compartment in an uninterrupted fashion as far as the floor and sides are concerned, such sides defining the railings of the truck bed being fitted with windows correlative to the passenger compartment windows and having their back edges adapted to the lock and hinge mechanisms connected to a horizontally opening back door, the backrest of said passenger compartment having a hinged door at the lintel, which we call a sixth door, integrated by a panel as high as the passenger compartment and as wide as the span between the upper edges of said railings, in the lower edge of which an occasional shorter panel can be folded inwards so that such sixth door can be vertically pulled out between a position separating the passenger compartment from the truck bed and a horizontal position to provide a roof for the truck bed, occasionally spreading out the existing shorter panel only when the truck bed length exceeds the height of the sixth door, thus integrating the truck bed with the passenger compartment, fitted with the known weatherstrip techniques to ensure air tightness, without the need of any keys to lock the roof because access is blocked by the back door closing, and affixation is achieved by an internal automatic locking system for both positions. In aspects of the present invention, the shorter panel is understood to have its own locking mechanism and the necessary flange so that it does not surpass the horizontal plane of the sixth door functioning as a roof.

In a further aspect, the lateral edges of the sixth door are preferably straight and parallel, and the panels that complete the cross silhouette of the vehicle remain in a fixed position at both sides of their rabbets.

In another aspect, as with the passenger compartment windows, the window panes on the sides of the truck bed and on the back door are retractable so that they hide inside the lower panels to avoid exposure to cracks during loading and unloading operations or any other use.

### BRIEF DESCRIPTION OF THE DRAWINGS

FIG. 1 is a back perspective view of a double cab pickup truck with an open truck bed.

FIG. 2 is a back perspective view of a double cab pickup truck with its truck bed integrated to the passenger compartment.

FIG. 3 is a cross sectional view of the means of articulation and air-tightness of the sixth door isolating the truck bed from the passenger compartment.

FIG. 4 is a cross sectional view of the means of articulation and air-tightness of the sixth door connecting the truck bed and the passenger compartment.

FIG. 5 is a cross sectional view of the linear means of air-tightness of the sixth door connecting the truck bed and the passenger compartment and a possible locking means.

### DETAILED DESCRIPTION

In order to support the advantages briefly commented here and for a better understanding thereof, a preferred embodiment of this invention is described below, which is schematically illustrated at no determined scale in the attached drawings, expressly making it clear that it should not be considered as restrictive, but as an example that intends to merely provide an illustration of the basic conception this invention is based on.

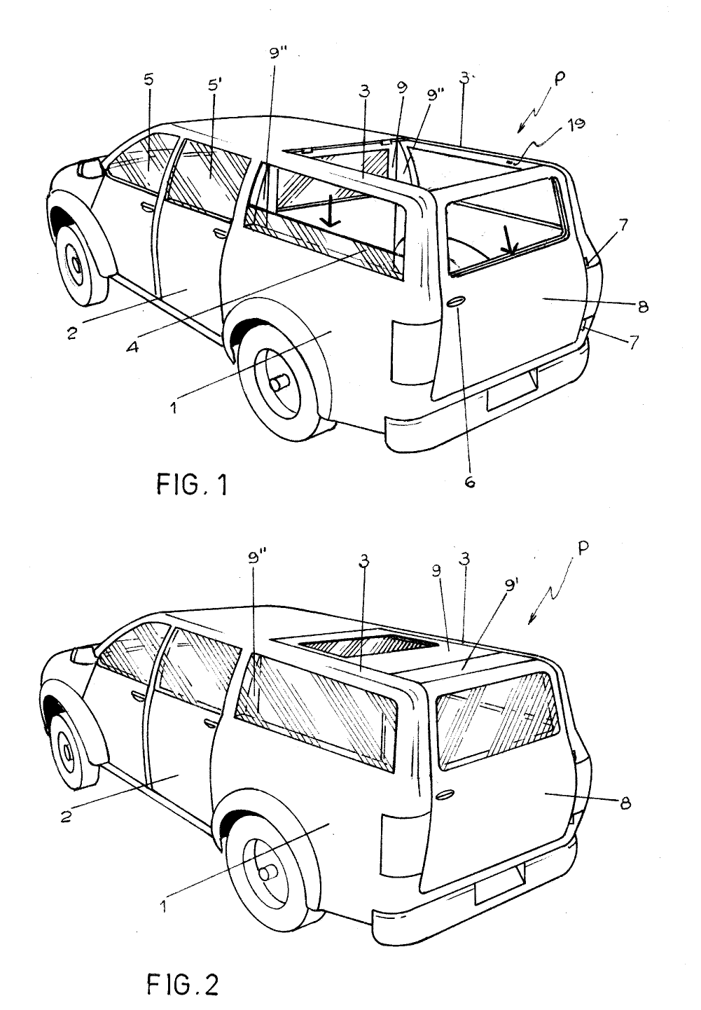

Referring to FIG. 1, the pickup truck (P) has its truck bed (1) and its double cab (2) arranged in an uninterrupted fashion as far as the floor and sides are concerned, such sides defining the railings (3) of the truck bed (1) being fitted with windows (4) correlative to the windows (5) and (5′) of the double cab passenger compartment (2), and having their back edges adapted to the lock mechanisms (6) connected to a horizontally opening back door (8), the backrest of said passenger compartment having a hinged door at the lintel (9), which we call sixth door, integrated by a panel as high as the passenger compartment and as wide as the span between the upper edges of said railings (3), in the lower edge of which an occasional shorter panel (9′) can be folded inwards, so that such sixth door (9) can be vertically pulled out between a position separating the passenger compartment (2) from the truck bed (1) and a horizontal position to provide a roof for the truck bed, occasionally spreading out the shorter panel (9′), as shown in the following figure.

As with the passenger compartment windows (5) and (5′), the window panes (4) on the sides (1) of the truck bed and on the back door (8) are retractable so that they may hide inside the respective lower panels to avoid exposure to cracks during tough loading and unloading operations.

As the lateral edges of the sixth door (9) must be straight and parallel, the panels (9″) that complete the cross silhouette of the vehicle remain in a fixed position at both sides of their rabbets.

Referring now to FIG. 2, shown is the sixth door (9) pulled open in a coplanar position from the roof of the passenger compartment (2), with the shorter panel (9′) spread out to define a roof for the truck bed (1) and integrate it to said passenger compartment, between air-tight joints with respect to the upper edges of the railings (3) and the back door (8).

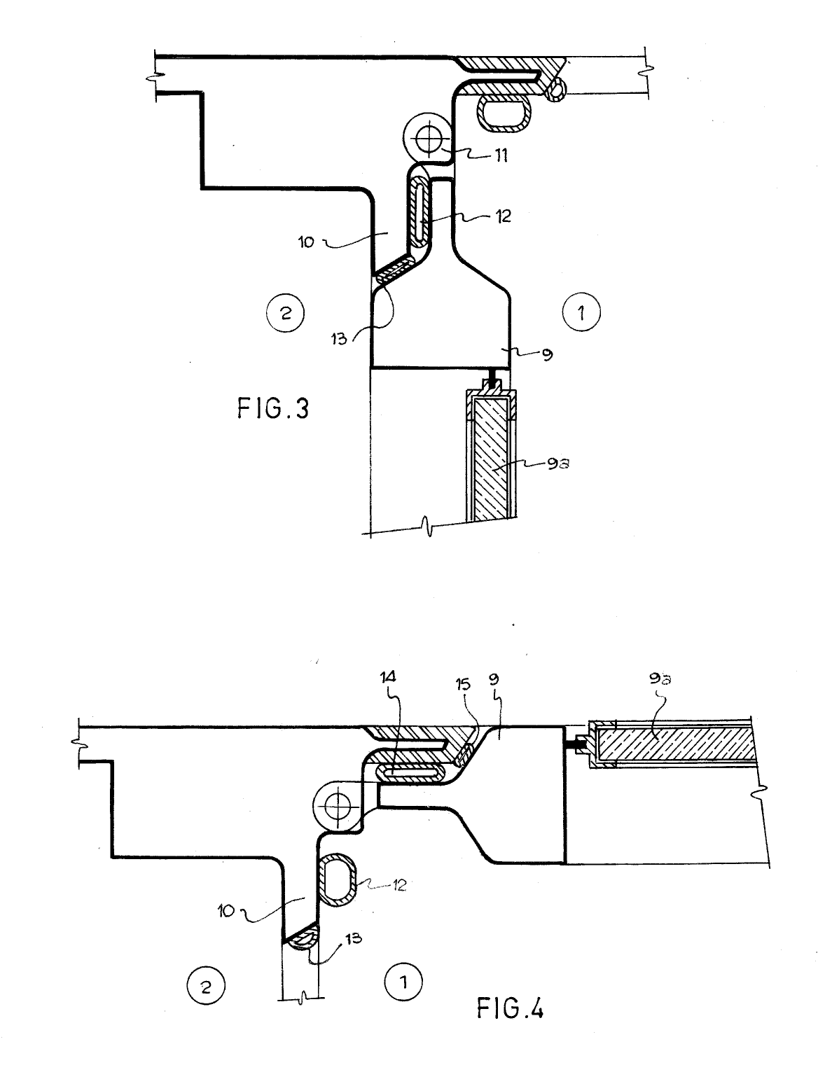

Referring now to FIG. 3, the cross section shows the connection between the sixth door (9) with a rear window (9a) and the upper crosspiece (10) that defines its lintel, by means of at least two hinges (11), such door being displayed in this figure in a vertical position blocking communication between the truck bed (1) and the passenger compartment (2), with the air-tightness provided by the weatherstrips (12) and (13).

Referring to FIG. 4, the cross section shows the connection between the sixth door (9) with a rear window (9a) and the upper crosspiece (10) that defines its lintel, by means of at least two hinges (11), such door being displayed in this figure in a horizontal position allowing communication between the truck bed (1) and the passenger compartment (2), with the air-tightness provided by the weatherstrips (14) and (15).

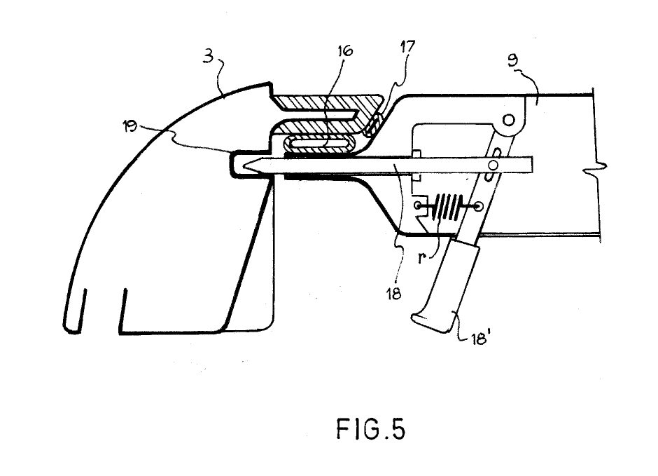

Referring to FIG. 5, the cross section shows the preferably air-tight connection between the sixth door (9) and the upper edges of the railings (3) of the truck bed (1) provided by the weatherstrips (16) and (17) after positional fixation achieved by inserting bolts (18) into housings (19), normally in locking position due to the spring (r) and being opened by means of the actuating lever (18′).

The truck bed to passenger compartment integrating mechanism in double and extended cab pickup trucks herein described and exemplified falls within the scope of protection of this application, which is basically defined by the following claims.

1. A truck bed to passenger compartment integrating mechanism in pickup trucks, comprising:
a pickup truck having a truck bed and a passenger compartment
wherein, arranged in an uninterrupted fashion as far as the floor and sides are concerned, sides defining the railings of the truck bed are fitted with windows parallel to the windows of the pickup truck passenger compartment, said sides having their back edges adapted to the lock mechanisms connected to a horizontally opening back door,
wherein the backrest of said passenger compartment has a hinged door at the lintel, which we call sixth door, integrated by a panel as high as the passenger compartment and as wide as the span between the upper edges of said railings, in the lower edge of which an optional shorter panel can be folded inwards, all arranged so that such sixth door can be vertically pulled out between a position separating the passenger compartment from the truck bed and a horizontal position to provide a roof for the truck bed.

2. The truck bed to passenger compartment integrating mechanism in pickup trucks of claim 1, wherein the optional shorter panel may be folded inwards around the lower edge of the sixth door when the length of the truck bed exceeds the height of the sixth door.

3. The truck bed to passenger compartment integrating mechanism in pickup trucks of claim 1, wherein the sides and back door have lower panels and the windows of the sides of the truck bed and the back door are retractable so that they can hide inside the respective lower panels.

4. The truck bed to passenger compartment integrating mechanism in pickup trucks of claim 1, wherein the sixth door has a locking mechanism which in both positions comprises inner bolts running transversally, which are inserted into slots arranged along the upper crossbars of the railings or into slots in the rabbets, normally in a locking position due to a pull spring and opening by a second class actuating lever, the resistance being said spring, said second class actuating lever having a grip which serves as a power point, and a point of support which is the lever articulation with respect to the sixth door.
